(19) United States
(12) Patent Application Publication
(10) Pub. No.: US 2009/0255085 A1
(43) Pub. Date: Oct. 15, 2009

(54) OVER-THE-DOOR ADJUSTABLE DOOR STOP

(75) Inventor: Javier A. Lorenzati, Barcelona (ES)

Correspondence Address: Levenfeld Pearlstein, LLC;Intellectual Property Department, 2 North LaSalle, Suite 1300, Chicago, IL, 60602, US

(73) Assignee: Nixiface, a Series of The Invention Machine, LLC, Glencoe, IL (US)

(21) Appl. No.: 12/100,124

(22) Filed: Apr. 9, 2008

(51) Int. Cl. E05F 5/00

(52) U.S. Cl. 16/82

(57) ABSTRACT

A decorative over-the-door, adjustable door stop includes two or more pocket-like body sections connected by an elongated strip. An interference member is positioned along the elongated strip, intermediate the body sections, at a predetermined location. The door stop is configured to reside over a top of the door with the interference member on the top of the door for contact with a frame of the door to maintain the door in an open state.

### BACKGROUND OF THE INVENTION

The present invention is directed to a door stop. More particularly, the present invention pertains to a decorative, adjustable door stop which is hung over a door and includes storage and/or display portions.

Door stops are commonly used in residences and commercial building alike to hold doors ajar. These door stops are usually small, unattractive, rubber devices that wedge between the door and the floor and usually need to be nudged with a foot to keep it, and the door, in place. Often, the bottom of the door stop becomes dirty and slides along the floor, failing in its task to keep the door open. In addition, these door stops sometimes get lost when kicked out of the way.

Moreover, these wedge-type door stops are intended to secure doors in a fully open position. That is, they cannot be effectively used to maintain doors in partially opened positions.

Door-mounted door stops are also used, but these can be difficult to install and may damage the door. These often require the use of installation hardware such as screws and the like. Moreover, these door-mounted stops typically do not allow for an adjustable open position of the door.

Accordingly, there is a need for a device that holds doors ajar that is attractive, easy to use and install. Desirably, such a door stop is reusable and removable, and is capable of keeping a door at a variety of angles.

### BRIEF SUMMARY OF THE INVENTION

An over-the-door, adjustable door stop includes an elongated strip, at least two body sections connected by the elongated strip and an interference member positioned along the elongated strip at a predetermined location intermediate the body sections. The door stop is configured to reside over a top of the door with the interference member on the top of the door for contact with a frame of the door to maintain the door in an open state.

The door stop holds a door ajar at a variety of angles. The door stop is attractive, easy to use and install. It is reusable and removable.

In a present embodiment, the elongated strip is formed from a flexible material. A compartment can be disposed on the strip intermediate the body sections. The interference member can be removably disposed in the compartment. The interference member is a wedge or dome-shaped element.

Alternately, the interference member can be formed from a hook and loop fastener system with a portion of the fastener system fixedly secured to the strip and the other part of the fastener system mounted to an element to increase a thickness of the interference member.

Alternately still, the interference member can be formed in part from a wedge mounted to the strip. The wedge can include a slit in a base thereof.

To prevent slippage, a portion of the strip and/or the elongated compartment is formed from a non-slip fabric. The body sections can be formed having a pocket formed and/or the body sections can include signage.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of an embodiment of the over-the-door adjustable door stop shown with the door stop is two different positions (one shown in phantom);

FIG. 2 is a plan view of the elongated compartment of the door stop;

FIG. 3A is a front view of a pocket of the door stop;

FIG. 3B is a rear view of one of the pockets of the door stop;

FIG. 4 is a plan view of an alternate embodiment of the door stop;

FIG. 4B is a side view of the interference member;

FIG. 5 is a plan view of still another alternate embodiment of the door stop;

FIG. 6A is a partial side view of the door stop of FIG. 5; and

FIG. 6B is a side view of the interference member of the door stop of FIGS. 5 and 6A.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

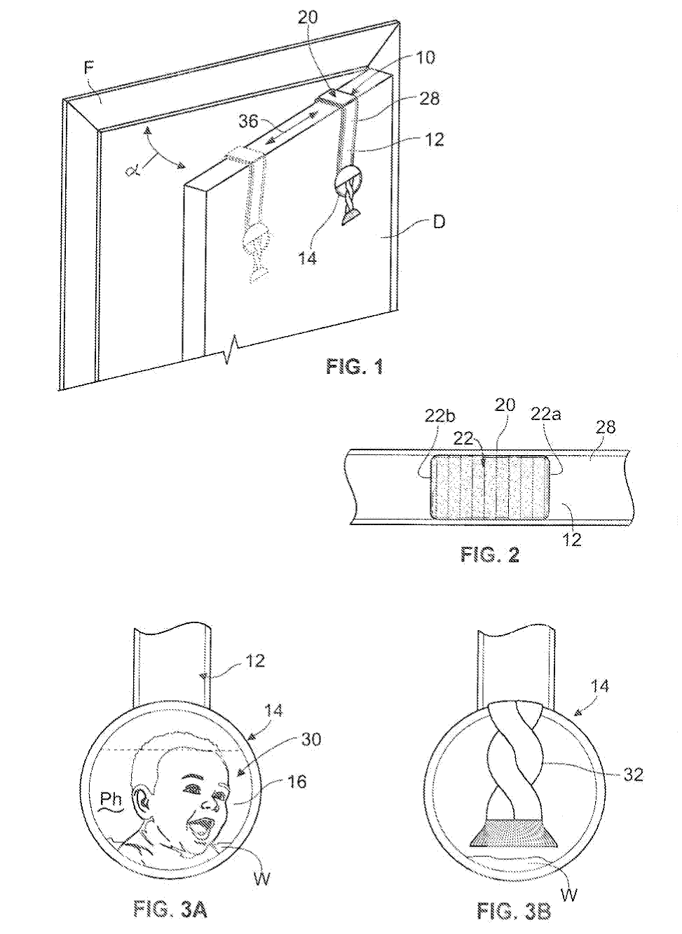

Referring now to the figures and in particular to FIG. 1, there is shown an embodiment of an over-the-door, adjustable door stop 10. The door stop 10 includes generally, two or more body sections 14 connected by an elongated strip 12. The body sections 14 can be formed having pockets 16. The body sections 14 can be formed as circular, oval, square, rectangular or any regular or irregular geometric shape, or any shape at all.

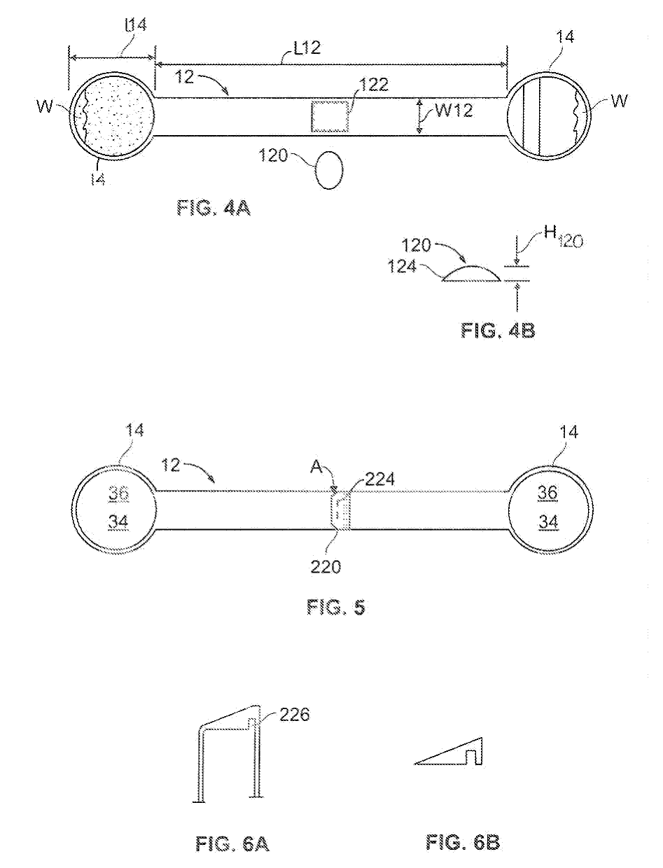

The strip 12 includes an interference member 20 about mid-way along a length 112 of the strip 12 that is positioned over the top of the door D. The strip 12 includes retaining means 22 to retain the interference member 20 in place on the strip 12. In one embodiment (see FIG. 4), the retaining means 122 is a compartment formed on the strip 12 (from, for example, a material secured around three sides to the strip) and the interference member 120 is contained within compartment 122. The compartment 122 is formed from a fabric, elastic, rubber or the like (see FIG. 4). The interference member 120 can be in the form of a rubber dome-shaped element with upwardly sloping sides 124. Elements of different heights h₁₂₀, from about 0.20 to about 0.70 inches in height can be used. It is also anticipated that an interference member 120 having a triangular cross-section (not shown) can be used.

As seen in FIGS. 1 and 2, the interference member 20 can be formed from an increased height textile element. The retaining means 22 can be provided by, for example, a textile element with one portion 22a of a hook and loop fastening system (such as VELCRO®) affixed to the strip 12 (or the portion of the hook and loop fastener can be affixed directly to the strip) and a second smaller textile element 20 with the other portion of the hook and loop fastener 22b, fastened to the to the strip 12 to increase the effective thickness of the strip 12. In any of the embodiments, the effect is to increase the thickness of the strip.

Alternately still, in a more thickset embodiment, such as may be used in an industrial environment, a wedge 220 can be affixed to the bottom of the strip 12 by adhesive A, a mechanical fastener 224 (e.g., a staple) or the like. The wedge 220 can include a slit 226 at about the upper (wide) end of the wedge 220. The slit 226 facilitates accommodating doors that may have an upper, upwardly extending lip, such as a weather seal. Alternately, the wedge can be formed without the slit and fabricated slightly less than the width of the door to accommodate the weather strip along the side of the wedge 220, between the wedge and the strip 12, to facilitate a good fit of the door stop 10 between the door D and the upper frame F.

The elongated strip 12 can be made of any flexible fabric or material, such as cloth or plastic. Alternately still, the strip 12 can be formed of rubber or an industrial grade (and suitable) polymeric material that is flexible and resilient. The strip 12 can be formed with a non-slip surface 28 (or formed of a non-slip material) so that when it is positioned on a door the door stop is less likely to slide or move along the door.

The door stop is decorative, as well as functional. As set forth above, and as seen in the figures, the door stop (two) body sections 14 can be formed having pockets 16 for storing items, such as portable music players, telephones and the like. The pocket front 30 can also be formed from a clear plastic material to allow photographs Ph to be stored and viewed. Decorative or ornamental elements 32 (such as tassels, braids or the like) can be included to provide a pleasing aesthetic to the door stop 10.

It is also anticipated that the front surface 34 of the body section 14 can be used in an informative manner. For example, it can be used to pin messages, it can include one part of a hook and loop fastening system or it can include a “white-board” surface 36, on which messages can be written. Other signage (e.g., STOP, WARNING, SLOW or the like) or advertising can be disposed on the body section 14. Of course, it will be appreciated that any such signage, advertising, storage pockets and the like can be removably or permanently affixed to the stop 10. In addition, the body section 14 can be formed with a chalk-board (e.g., slate) surface to permit posting messages on the body section 14 faces. The body section 14 can also include a magnetic element (not shown) to facilitate attaching items (such as ornamental items) to the body or to permit attracting (or “attaching”) the door stop to metal doors.

The body sections 14 should be of a sufficient weight to allow the door stop 10 to lie flat against the door D and to prevent the door stop 10 from sliding along the door D. As such small weights W, sand or the like may be contained within the body sections 14 to provide weight as necessary. Of course, if the weight of the materials of construction alone are sufficient, then no additional weight may be needed.

The strip 12, as well as the fabric and thickness of the compartment wedges, maintain the over-the-door, adjustable door stop 10 on the door D and maintains the angle α at which the door D is held open.

The door stop 10 is draped over the door D with the two body sections 12 resting flat against either side of the door D. The interference element 20, 120, 220 (which may be contained within the compartment 18) rests along the top edge of the door D. No mounting supplies, such as nails or screws, are necessary. After the door stop 10 is positioned on the door D, the door D is closed until the door stop engages the door frame F. The door D compresses the interference member 20, 120, 220 against the frame F, and the interference member 20, 120, 220 prevents the door D from closing completely. The non-slip surface 28 prevents the door stop 10 from sliding (along the top of the door D or down one of the faces of the door D) out of position.

The angle α at which the door D is held open is determined by the position of the door stop 10. Moving the door stop 10 along the top of the door D, as shown by directional arrow at 36, enables the user to adjust the angle α at which the door D is open.

The strip 12 can be configured have a length 112 (exclusive of the body sections) of about 25 to about 36 inches. The body sections 14 can have a length 114 (and a width) of about 5 inches to about 6 inches. The width w₁₂ of the strip 12 can be about 2.0 to about 2.5 inches.

The advantages to the present door stop 10 are numerous. First, the door can be held open at a wide variety of angles (e.g., slightly ajar to a large opening). The door stop 10 can prevent a door D from completely closing unexpectedly and possibly causing injury. In addition, the door stop 10 does not require any installation, hardware, drilling or screwing. It is easily removable and may be washable (depending upon the materials of construction) and can be repositioned multiple times without damaging the door D or surrounding areas. The door stop 10 can also provide an aesthetically appealing ornamentation, and can even be used as a message center in a residence, office or commercial setting. The door stop 10 can also be used to maintain a door D slightly ajar to provide ventilation within a room.

All patents referred to herein, are incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. An over-the-door, adjustable door stop comprising:
an elongated strip;
at least two body sections connected by the elongated strip;
an interference member positioned along the elongated strip, intermediate the body sections, at a predetermined location; and
a compartment disposed on the strip intermediate the body sections, wherein the interference member is removably disposed in the compartment,
wherein the door stop is configured to reside over a top of the door with the interference member on the top of the door for contact with a frame of the door to maintain the door in an open state.

2. The over-the-door, adjustable door stop in accordance with claim 1 wherein the elongated strip is formed from a flexible material.

3. (canceled)

4. The over-the-door, adjustable door stop in accordance with claim 1 wherein the interference member is a wedge or dome-shaped element.

5. The over-the-door, adjustable door stop in accordance with claim 1 wherein the interference member is formed in part from a hook and loop fastener system and wherein a portion of the hook and loop fastener system is fixedly secured to the strip and another part of the hook and loop fastener system is mounted to an element to increase a thickness of the interference member.

6. An over-the-door, adjustable door stop comprising:
an elongated strip;
at least two body sections connected by the elongated strip;
an interference member positioned along the elongated strip, intermediate the body sections, at a predetermined location, the interference member being formed in part from a wedge mounted to the strip, the wedge having a slit in a base thereof transverse to an angled surface of the wedge,
wherein the door stop is configured to reside over a top of the door with the interference member on the top of the door for contact with a frame of the door to maintain the door in an open state.

7. (canceled)

8. The over-the-door, adjustable door stop in accordance with claim 1 wherein a portion of the compartment is formed from a non-slip fabric.

9. The over-the-door, adjustable door stop in accordance with claim 1 wherein one or more of the body sections have a pocket formed therein.

10. The over-the-door, adjustable door stop in accordance with claim 1 wherein one or both of the body sections include signage.

11. An over-the-door, adjustable door stop comprising:
an elongated strip having two body sections connected by the elongated strip;
an interference member positioned along the elongated strip, intermediate the body sections, at a predetermined location; and
a compartment disposed on the strip intermediate the body sections and wherein the interference member is removably disposed in the compartment,
the door stop being configured to reside over a top of the door with the interference member on the top of the door for contact with a frame of the door to maintain the door in an open state.

12. The over-the-door, adjustable door stop in accordance with claim 11 wherein the retaining means is formed as a compartment disposed on the strip and the interference member is a removable element fitted into the compartment.

13. The over-the-door, adjustable door stop in accordance with claim 11 wherein the retaining means is a hook and loop fastening system, one portion of which is affixed to the strip and another portion of which is affixed to a thickness increasing member.

14. The over-the-door, adjustable door stop in accordance with claim 13 wherein the thickness increasing member is a portion of textile material.

15. The over-the-door, adjustable door stop in accordance with claim 11 wherein the interference member is formed in part from a wedge and wherein the wedge is mounted to the strip by a mechanical fastener.
